(19) United States
(12) Patent Application Publication
(10) Pub. No.: US 2026/0254846 A1
(43) Pub. Date: Aug. 27, 2026

(54) DENIAL OF SERVICE ATTACK MITIGATION SYSTEM

(71) Applicant: AT&T Intellectual Property I, L.P., Atlanta, GA (US)

(72) Inventors: Savitha Iyer, Mountain House, CA (US); Sherry Gelenius, Wall Township, NJ (US); Xiao Pan, Middletown, NJ (US); Stephen Hutnik, Hawthorne, NY (US)

(21) Appl. No.: 19/061,850

(22) Filed: Feb. 24, 2025

(51) Int. Cl. H04L 9/40; H04L 41/16

(52) U.S. Cl. CPC H04L 63/1458; H04L 41/16

(57) ABSTRACT

A processing system including at least one processor may obtain a denial of service attack alert for a denial of service attack. The processing system may next apply an input vector comprising information associated with the denial of service attack alert to a machine learning model implemented by the processing system that is configured to generate an output comprising a mitigation priority value. The processing system may then transmit at least one instruction to at least one denial of service attack scrubber unit to mitigate the denial of service attack in response to the mitigation priority value indicating that the denial of service attack is to be mitigated.

The present disclosure relates generally to network monitoring and troubleshooting, and more specifically to methods, computer-readable media, and apparatuses for transmitting at least one instruction to at least one denial of service attack scrubber unit to mitigate a denial of service attack in response to a mitigation priority value obtained via a machine learning model indicating that the denial of service attack is to be mitigated.

### BACKGROUND

Network monitoring systems receive, store, and process, large volumes of network performance data, e.g., key performance indicators (KPIs) relating to network devices, network segments/zones, subnets, cell sites, data centers, and so forth. Such network monitoring systems may also receive alerts and/or may process the various network performance data to generate alerts relating to data traffic loading conditions at devices, over links, etc., relating to malicious activity, such as botnet activity, spam, fraud, network probing, and denial of service (DoS) attacks, such as distributed denial of service (DDoS) attacks, and so forth. Particularly with respect to malicious activity, such as DoS attacks, alerting thresholds may be set conservatively so as to not miss detection of an attack. However, this may result in many false positives, which may consequently involve a significant allocation of human or automated resources to clear these false positives and to separate out the true alerts. Nevertheless, many false positives may still fail to be correctly classified as such. Accordingly, a communication network may still devote significant resources to the mitigation of a perceived malicious activity.

### SUMMARY

In one example, the present disclosure describes a method, computer-readable medium, and apparatus for transmitting at least one instruction to at least one denial of service attack scrubber unit to mitigate a denial of service attack in response to a mitigation priority value obtained via a machine learning model indicating that the denial of service attack is to be mitigated. For instance, in one example, a processing system including at least one processor may obtain a denial of service attack alert for a denial of service attack. The processing system may next apply an input vector comprising information associated with the denial of service attack alert to a machine learning model implemented by the processing system that is configured to generate an output comprising a mitigation priority value. The processing system may then transmit at least one instruction to at least one denial of service attack scrubber unit to mitigate the denial of service attack in response to the mitigation priority value indicating that the denial of service attack is to be mitigated.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example process for ingesting new DoS attack alerts and retiring existing/older DoS attack alerts, in accordance with the present disclosure;

FIG. 3 illustrates an example flowchart of a method for transmitting at least one instruction to at least one denial of service attack scrubber unit to mitigate a denial of service attack in response to a mitigation priority value obtained via a machine learning model indicating that the denial of service attack is to be mitigated; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for transmitting at least one instruction to at least one denial of service attack scrubber unit to mitigate a denial of service attack in response to a mitigation priority value obtained via a machine learning model indicating that the denial of service attack is to be mitigated.

In particular, examples of the present disclosure may include a processing system that is configured to process denial of service (DoS) alerts and to determine whether DoS attacks associated with such alerts should be mitigated using one or more DoS scrubbing devices, or DoS scrubbers (also referred to as DoS attack mitigation devices). In one example, such a processing system may be referred to as a DoS mitigation manager. For instance, in one example, the DoS mitigation manager may implement a machine learning model (MLM) that may process input data about an alert, such as a misuse type (or misuse types, where an alert can have multiple misuse types), a data traffic volume or rate, a data traffic volume or rate scaled per misuse type (or misuse types), a source country (or countries) of the attack, one or more source internet protocol (IP) addresses, and/or other factors to generate an output indicative of whether the associated DoS attack should be mitigated or not (e.g., at a present time). The output may be a priority value or score, a classification (e.g., a binary classification or a multi-class classification with three or more classes/categories), or the like. Based on the output classification and/or score/value, the DoS mitigation manager may decide whether to send traffic of the DoS attack to one or more DoS scrubbing devices. If the decision is to not send the traffic to the DoS scrubbing devices, then the DoS mitigation manager may wait for a configurable time period, such as N seconds, and check again (e.g., applying a new input vector to the MLM, in which some of the input factors may have changed). This may continue until the particular DoS alert ends. The DoS mitigation manager may also check the DoS scrubbing devices to determine if any mitigation should end. For instance, the DoS mitigation manager may continue to evaluate input vectors comprising data associated with DoS alerts, where changing parameters may cause the output of the MLM to indicate a different mitigation decision. For instance, a DoS attack currently in mitigation may be determined to no longer warrant mitigation. As such, the DoS mitigation manager may instruct one or more DoS scrubbing devices to end DoS attack mitigation for the particular DoS attack.

Notably, prior approaches may include mitigations on DoS scrubbing devices based on DoS alerts for various misuse types such as Transmission Control Protocol (TCP) synchronization (SYN) attacks, Domain Name System (DNS) amplification attacks, etc. Thresholds may be set manually by the threat analysts for each customer per misuse type. When a threshold is exceeded for any given misuse type, the traffic may be sent to the DoS scrubbing devices to mitigate an assumed DoS attack. To not miss any attacks, the thresholds may typically be set conservatively low. However, the DoS scrubbing devices have finite capacity. As such, this arrangement may result in overwhelming the DoS scrubbing devices. As a consequence, valid DoS attacks may potentially be missed because mitigations of multiple false positive or non-consequential DoS attacks may be active on one or more of the DoS scrubbing devices, thereby consuming available capacities and resources of the DoS scrubbing devices.

As noted above, to manage the finite capacity of the DoS scrubbing devices, examples of the present disclosure may deploy a DoS mitigation manager that will decide if data traffic for any given DoS alert should be mitigated or not. Accordingly, the DoS scrubbing devices may now be more effectively utilized by prioritizing mitigation of DoS attacks that are most important to address. In addition, the DoS mitigation manager may similarly pull active mitigations from DoS scrubbing devices when appropriate in order to free capacity for new/additional DoS attacks. In this regard, it is noted that examples of the present disclosure may seek to begin mitigations as late as possible and to end mitigations (e.g., to stop the mitigations on the DoS scrubbing devices) as early as possible while maximizing mitigation effectiveness. Notably, existing DoS scrubbing device deployments may not classify or prioritize the DoS alerts. In addition, these prior approaches may lack intelligence spanning across multiple DoS scrubbing devices and vendors equipment types. As such, these approaches also do not free up DoS attack mitigation capacity through early termination of existing mitigations.

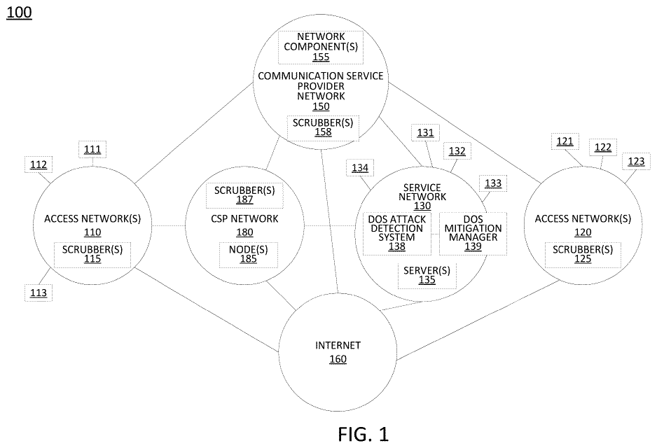

In contrast, examples of the present disclosure may provide a more efficient utilization of DoS scrubbing devices using a DoS mitigation manager as described herein. In particular, the DoS mitigation manager may manage DoS scrubbing devices such that DoS attacks that are true attacks (e.g., non-false positives) and that are of sufficient priority are mitigated, and only then for as short of a duration as warranted in view of other current DoS attacks. Additionally, in one example, DoS attack mitigation may proceed in a priority order. Alternatively, or in addition, in one example, the DoS mitigation manager may arbitrate across a plurality of DoS scrubbing devices from one or multiple different vendors to perform the DoS attack mitigations. As such, examples of the present disclosure may provide the same mitigation capabilities with fewer DoS scrubbing devices and/or may offer enhanced mitigation capacity with a same number of DoS scrubbing devices as compared to prior deployments. In addition, communication networks, data centers, customer premises networks, and so forth may remain better protected from DoS attacks as a result of the DoS mitigation manager selectively focusing on mitigation of those DoS attacks with higher importance/priority. Thus, examples of the present disclosure may be employed in communication network operations and automations (e.g., artificial intelligence for information technology (IT) operations (AIOps)). Examples of the present disclosure may alternatively or additionally include monitoring and/or reconfiguring of a communication network (e.g., including selective data traffic handling) in response to one or more DoS alerts. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure for may operate. Communication service provider network 150 may comprise a core network with components for telephony services, Internet services, data services, texting services, and/or video services (e.g., triple-play services, etc.) that are provided to customers (broadly “subscribers”), and to peer networks. In one example, communication service provider network 150 may combine core network components of a cellular network with components of a triple-play service network. For example, communication service provider network 150 may functionally comprise a fixed-mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 150 may also further comprise a broadcast video network, e.g., a traditional cable provider network or an Internet Protocol Television (IPTV) network, as well as an Internet Service Provider (ISP) network. With respect to video service provider functions, communication service provider network 150 may include one or more video servers (e.g., television servers) for the delivery of video content, e.g., a broadcast server, a cable head-end, a video-on-demand (VoD) server, and so forth. For example, communication service provider network 150 may comprise a video super hub office, a video hub office and/or a service office/central office.

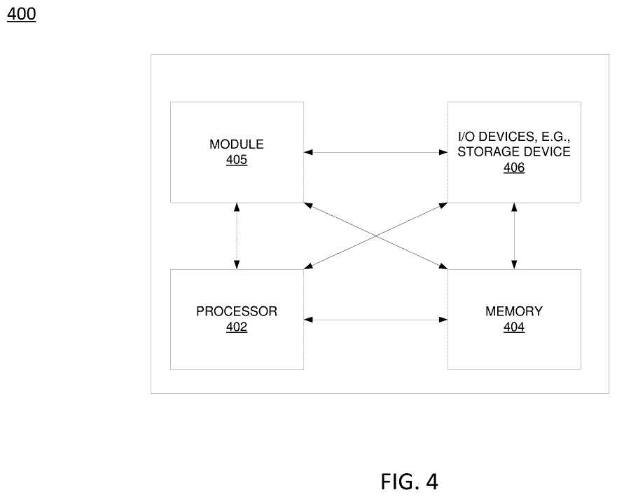

In one example, communication service provider network 150 may also include one or more network components 155. In one example, the network component(s) 155 may each comprise a computing system, such as computing system 400 depicted in FIG. 4, and may be configured to host one or more network components in accordance with the present disclosure. For example, a first network component may comprise a database of assigned telephone numbers, a second network component may comprise a database of basic customer account information for all or a portion of the customers/subscribers of the communication service provider network 150, a third network component may comprise a cellular network service home location register (HLR), e.g., with current serving base station information of various subscribers, and so forth. Other network components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components may include, for example, a layer 3 router, a short message service (SMS) server, a voicemail server, a video-on-demand server, a server for network traffic analysis, a database server/database system, and so forth. It should be noted that in one example, a network component may be hosted on a single server, while in another example, a network component may be hosted on multiple servers, e.g., in a distributed manner. For ease of illustration, various components of communication service provider network 150 are omitted from FIG. 1.

In one example, various components of communication service provider network 150 comprise network function virtualization infrastructure (NFVI), e.g., software defined network (SDN) host devices (i.e., physical devices) configured to operate as various virtual network functions (VNFs), such as a Short Message Service (SMS) server, a voicemail server, a video-on-demand server, etc. For instance, network component(s) 155 may represent any one or more NFVI/SDN host devices configured to operate as any one or more of such VNFs. Similarly, in an example in which communication service provider network 150 may comprise a cellular core network, network component(s) 155 may represent NFVI hosting one or more of a virtual user plane function (vUPF), a virtual access management function (vAMF), a virtual session management function (vSMF), a virtual network slice selection function (vNSSF), etc., or a virtual MME (vMME), a virtual HHS (vHSS), a virtual serving gateway (vSGW), a virtual packet data network gateway (vPGW), and so forth. Thus, for example, network component(s) 155 may comprise a vMME, a vSGW, a virtual access management function (AMF), a virtual network slice selection function (NSSF), a virtual user plane function (UPF), and so forth.

In one example, access networks 110 and 120 may each comprise a cellular or wireless access network, a fiber-optic access network, a broadband cable access network, Digital Subscriber Line (DSL) network, a Local Area Network (LAN), and the like. For example, access networks 110 and 120 may transmit and receive communications between devices 111-113, devices 121-123, and service network 130, and between communication service provider network 150 and devices 111-113 and 121-123 relating to voice telephone calls, communications with web servers via the Internet 160, and so forth. Access networks 110 and 120 may also transmit and receive communications between devices 111-113, 121-123 and other networks and devices via Internet 160. For example, one or both of the access networks 110 and 120 may comprise an Internet service provider (ISP) network, such that devices 111-113 and/or 121-123 may communicate over the Internet 160, without involvement of the communication service provider network 150. Devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of devices 111-113 and 121-123 may represent one or more user devices and/or one or more servers of one or more other entities, such as a financial institution, an educational institution, a healthcare entity, a governmental entity, etc.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the communication service provider network 150. For example, each of the access networks 110 and 120 may comprise an ISP network, a cable access network, and so forth. In another example, each of the access networks 110 and 120 may comprise a cellular access network, implementing such technologies as: a 3^{rd} Generation Partnership Project (3GPP) 5G and/or 4G/LTE radio access network (RAN), or the like, a global system for mobile communication (GSM) base station subsystem (BSS), a GSM enhanced data rates for global evolution (EDGE) radio access network (GERAN), or a Universal Mobile Telecommunications System (UMTS) terrestrial radio access network (UTRAN) network, among others, where communication service provider network 150 may provide core network functions, e.g., of 5G core network, a 4G/LTE core network, a public land mobile network (PLMN)-universal mobile telecommunications system (UMTS)/General Packet Radio Service (GPRS) core network, or the like. In such an example, access networks 110 and 120 may include one or more cell sites, which may include antenna arrays (e.g., remote radio heads (RRHs), base station equipment and/or one or more components thereof (e.g., a distributed unit (DU) and/or centralized unit (CU), etc.), transformers, battery units, and/or or other power equipment, and so forth. In still another example, access networks 110 and 120 may each comprise a home network or enterprise network, which may include a gateway to receive data associated with different types of media, e.g., video, phone, and Internet/data, and to separate these communications for the appropriate devices. For example, data communications, e.g., Internet Protocol (IP) based communications, may be sent to and received from a router in one of the access networks 110 or 120, which receives data from and sends data to the devices 111-113 and 121-123, respectively.

In this regard, it should be noted that in some examples, devices 111-113 and 121-123 may connect to access networks 110 and 120 via one or more intermediate devices, such as a gateway and router, e.g., where access networks 110 and 120 comprise cellular access networks, ISPs and the like, while in another example, devices 111-113 and 121-123 may connect directly to access networks 110 and 120, e.g., where access networks 110 and 120 may comprise local area networks (LANs), enterprise networks, and/or home networks, and the like.

In one example, system 100 may also include a cloud service provider (CSP) network 180 having one or more host devices, or nodes 185, which may each comprise networked computing resources for providing cloud services directly on behalf of CSP network 180 and/or for third parties having project development environments, data storage, and/or applications/services hosted via CSP network 180. For instance, node(s) 185 may comprise public or private cloud computing resources in one or more data centers, such as central processing units (CPUs), graphics processing units (GPUs), memory, storage devices, and so forth. The computing resources may operate as servers for hosting virtual machines, containers, microservices, or the like providing various applications, may operate as storage systems for storing databases, data tables, graphs, and so on. In one example, CSP network 180 may comprise a content distribution network (CDN) or at least a portion thereof. In various examples, CSP network 180 may be provided by a same entity as communication service provider network 150 or a different entity. It should also be noted that in one example, access networks 110 and/or 120 may comprise “edge clouds” which may similarly include host devices/nodes for providing cloud services such as mentioned above, but in locations that may be physically closer to various endpoint devices that may utilize such services. In one example, the node(s) 185 may host network components as described above, such as vUPFs, vAMFs, etc.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the communication service provider network 150. For example, the service network 130 may comprise one or more devices, such as servers 135, for providing services to subscribers, customers, and/or users. For example, communication service provider network 150 may provide a cloud storage or other cloud computing services, web server hosting, and other services. As such, service network 130 may represent aspects of communication service provider network 150 where infrastructure for supporting such services (e.g., server(s) 135) may be deployed. In one example, the service network 130 may alternatively or additionally comprise one or more devices supporting operations and management of communication service provider network 150. For instance, server(s) 135 may alternatively or additionally include higher level services/applications such as a database of assigned telephone numbers, a database of basic customer account information for all or a portion of the customers/subscribers of the communication service provider network 150, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 135 may alternatively or additionally comprise one or more of the types of network components 155 described above. In one example, service network 130 may provide network management (e.g., including outage monitoring, troubleshooting, remediation, etc.) as a service to various other entities. For instance, in a managed information technology (IT) scenario, a provider and consumer enter into an agreement for proactive monitoring and support for managed assets (broadly, network elements).

In one example, server(s) 135 may collect and store network operational data from the communication service provider network 150, access networks 110 and 120, CSP network 180, or other portions of the system 100. For instance, the network operational data may include: packet flow records, mobile device location data, control plane signaling and/or session management messages, data traffic volume records, e.g., per device, per interface or port, per link, etc., call detail records (CDRs), error reports, network impairment records, performance logs, alarm data, radio access network (RAN) metrics, such as peak or average number of radio access bearers, average or peak upload or download data volumes per bearer and/or per connected user equipment (UE)/endpoint device, etc., such as from one or more of the access networks 110 or 120, peak or average number of connection requests to a server, link utilization metrics (e.g., peak or average bandwidth utilization in terms of total volume or percentage of maximum link capacity), etc., and other information and statistics, which may then be compiled and processed, e.g., normalized, transformed, tagged, etc., and forwarded to servers 135.

In accordance with the present disclosure, server(s) 135 may further store network inventory records, e.g., comprising geographic features, such as a network element location (e.g., coordinates, building location, floor location within building, etc.), a site type, a location class (e.g., urban, suburban, rural, etc.), etc., and asset attributes/features, such as: a network element type (e.g., an asset class), a version, etc., a memory capacity, processor specifications, ports used, line card specifications, connected devices (e.g., a serving router, gateway, firewall, etc.), an operating system type, a manufacturer, available accessories, and so forth. In one example, a network inventory record may alternatively or additionally include a deployment date, a last serviced date, a frequency of service score, an asset priority of the network element (e.g., low, normal, high, critical, or unknown, or the like), an impact score of the network element (e.g., minimal, minor, medium, major, critical, or unknown, or the like), a service level class of the network element (e.g., according to an SLA or the like), a security zone of the network element, and so forth. It should be noted that in one example, such records may also relate to devices and/or systems that are “external” to network operator infrastructure, such as devices 111-113 and/or 121-123 comprising web servers of one or more other entities (such as a financial institution, an educational institution, a healthcare entity, a governmental entity, etc.) that may be monitored and protected in a managed IT arrangement.

In one example, server(s) 135 may include cloud-based and/or distributed data storage and/or processing systems comprising one or more servers at a same location or at different locations. For instance, server(s) 135 may represent a distributed file system, e.g., a Hadoop® Distributed File System (HDFS™), or the like. In this regard, server(s) 135 may maintain communications with one or more of the devices 111-113 and/or devices 121-123 via access networks 110 and 120, communication service provider network 150, Internet 160, and so forth, e.g., in order to collect network operational data. Similarly, server(s) 135 may maintain communications with one or more devices in communication service provider network 150 (e.g., network component(s) 155, etc.), CSP network 180, and/or access network(s) 110 and/or 120 in order to collect network operational data, e.g., for detecting DoS attacks and/or for other purposes.

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the communication service provider network 150, devices 131-134 of the service network 130 may comprise devices of network personnel, such as network operations personnel and/or personnel for network maintenance, network repair, construction planning, and so forth. Similarly, personnel using devices 131-134 may also be engaged in providing network management (e.g., including outage monitoring, troubleshooting, remediation, etc.) as a service to various other entities. Thus, for example, alarms/trouble tickets relating to various network issues, e.g., including denial of service (DoS) attacks, may be provided to devices 131-134.

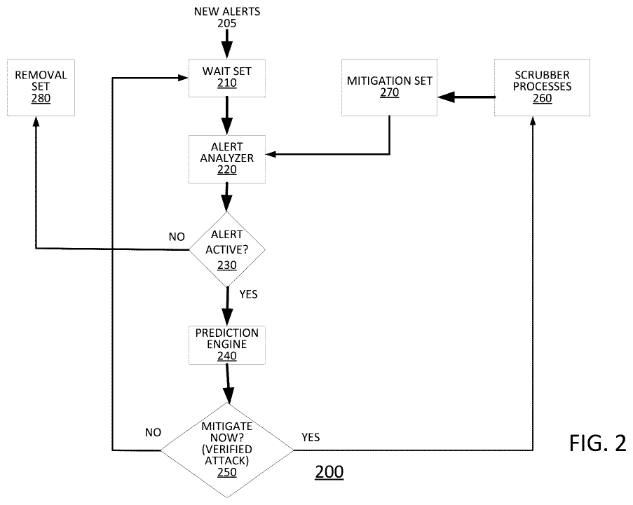

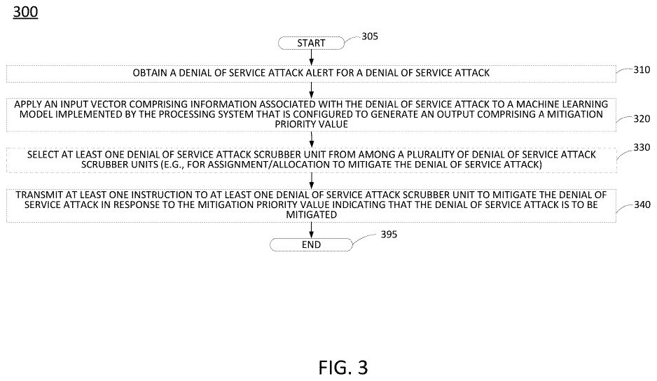

In one particular example, service network 130 may include a denial of service (DoS) attack detection system 138. For instance, DoS attack detection system 138 may comprise all or a portion of a computing device or system, such as computing system 400, and/or processing system 402 as described in connection with FIG. 4 below (or multiple instance of such a computing system) specifically configured to perform various steps, functions, and/or operations in connection with examples of the present disclosure for transmitting at least one instruction to at least one denial of service attack scrubber unit to mitigate a denial of service attack in response to a mitigation priority value obtained via a machine learning model indicating that the denial of service attack is to be mitigated. For example, DoS attack detection system 138 may perform operations in connection with the example process 200 of FIG. 2, the example method 300 of FIG. 3, or as otherwise described herein. In one example, the DoS attack detection system 138 may represent and/or may be a component of a platform comprising a network monitoring system, a trouble ticket system, and so forth (e.g., a network-based and/or cloud-based service hosted on hardware infrastructure of service network 130).

To further illustrate, DoS attack detection system 138 may obtain and analyze various network operational data to detect DoS attacks. For instance, as noted above, various network operational data may be collected and stored by server(s) 135, which may be accessed by DoS attack detection system 138. Alternatively, or in addition, DoS attack detection system 138 may poll, subscribe to, or otherwise obtain network operational data directly from various network elements (e.g., in one example, without the involvement of server(s) 135). In one example, DoS attack detection system 138 may apply one or more techniques to detect DoS attacks, such as anomaly detection and/or signature matching. For instance, anomaly detection may use clustering methods, statistical methods, machine learning (ML)-based methods, and so forth, e.g., using one or more aspects of network operational data as inputs/input data vectors. The DoS attack detection system 138 may monitor network operational data to detect DoS attacks on various protected systems, such as: DNS servers, NFVI/host devices, network slices, etc. (e.g., which may be represented by network component(s) 155), cloud computing infrastructure (e.g., node(s) 185), network database systems (e.g., server(s) 135), access network components, and so forth. As noted above, DoS attacks may also be directed at computing systems of various entities such as a financial institution, an educational institution, a healthcare entity, a governmental entity (e.g., which may be represented by 121-123, for example). Thus, DoS attack detection system 138 may monitor network operational data relating to any or all of such protected devices and/or systems in order to detect one or more DoS attacks.

For a detected DoS attack the DoS attack detection system 138 may generate a DoS attack alert/report, which may include a time of the detection, a duration, one or more source internet protocol (IP) addresses associated with the attack, one or more flow identifiers (e.g., a source tuple (e.g., a source IP address and port) and/or destination tuple (e.g., destination IP address and port)), a data volume, a country or countries of origin and/or destination, a target IP address, IP address range, or the like, a target domain or system, a misuse type (or misuse types) (e.g., a type or category of DoS attack, such as: a domain name system (DNS) flood misuse type, a DNS amplification misuse type, an IP fragmentation misuse type, a Transmission Control Protocol (TCP) synchronization flood misuse type, a Network Time Protocol (NTP) amplification misuse type, a Uniform Datagram Protocol (UDP) attack misuse type, a Connection-Less Lightweight Directory Access Protocol (CLDAP) amplification misuse type, a TCP reset flood misuse type, or the like), and so forth.

In addition, service network 130 may also include a denial of service (DoS) mitigation manager 139. For instance, DoS mitigation manager 139 may comprise all or a portion of a computing device or system, such as computing system 400, and/or processing system 402 as described in connection with FIG. 4 below (or multiple instance of such a computing system) specifically configured to perform various steps, functions, and/or operations in connection with examples of the present disclosure for transmitting at least one instruction to at least one denial of service attack scrubber unit to mitigate a denial of service attack in response to a mitigation priority value obtained via a machine learning model indicating that the denial of service attack is to be mitigated. For example, DoS mitigation manager 139 may perform operations in connection with the example method 200 of FIG. 2, the example method 300 of FIG. 3, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In this regard, it is also noted that the system 100 may additionally include DoS attack scrubbers, e.g., scrubbers 115, 125, 158, and 187, deployed in various portions of the system 100. For instance, the utilization of the various scrubbers 115, 125, 158, and/or 187 may be coordinated, controlled, or otherwise managed by the DoS mitigation manager 139. To further illustrate, DoS mitigation manager 139 may obtain a DoS attack alert for a DoS attack, e.g., from the DoS attack detection system 138. The DoS attack alert may identify a misuse type. In addition, the DoS attack alert may include further information about the DoS attack, such as: a source IP address, a source autonomous system number, a traffic volume, a normalized traffic volume per misuse type, a source country, a normalized traffic volume per source country, and so forth. The DoS mitigation manager 139 may then apply an input vector comprising information associated with the DoS attack alert to a machine learning model (MLM) implemented by the DoS mitigation manager 139 that is configured to generate an output comprising a mitigation priority value. The DoS mitigation manager 139 may further instruct at least one scrubber (e.g., one or more of the scrubbers 115, 125, 158, and 187) to mitigate the DoS attack in response to the mitigation priority value indicating that the DoS attack is to be mitigated. For instance, the mitigation priority value (e.g., a score) may indicate that the DoS attack is to be mitigated when the mitigation priority score exceeds a threshold. For example, the threshold may be set based upon load levels of the scrubbers 115, 125, 158, and/or 187 (e.g., based on the capacity/availability of the 115, 125, 158, and/or 187). In another example, the mitigation priority value may comprise a binary indicator of whether to mitigate the DoS attack at a present time.

In one example, the DoS mitigation manager 139 may select the one or more scrubbers based upon a misuse type associated with the DoS attack. For instance, the DoS mitigation manager 139 may apply, in response to the mitigation priority value indicating that the DoS attack is to be mitigated, a second input vector comprising second information associated with the DoS attack alert to a second machine learning model (MLM) implemented by the DoS mitigation manager 139 that is configured to generate a second output comprising a selected DoS attack scrubber unit type. In other words, the selected one or more scrubbers may be of the selected DoS attack scrubber unit type. In addition, in one example, the one or more scrubbers may be selected based on a capacity/load/availability of the one or more scrubbers, such as assigning to a scrubber that is least loaded or with the most spare capacity, assigning to scrubbers that have more than a minimum available capacity in a round robin fashion, assigning to scrubbers randomly with a weighting/bias for each scrubber based on the scrubbers' capacities/loads, and so forth. Alternatively, or in addition, scrubbers may also be selected based on customer attributes, such as customer priority, budget, etc.

In one example, the DoS mitigation manager 139 may monitor the DoS attack remediation (e.g., the “scrubbing” of traffic associated with the DoS attack via the one or more selected scrubbers). In one example, DoS mitigation manager 139 may continue to evaluate whether a particular DoS attack should be mitigated through the use of scrubbers. For instance, a DoS attack that was detected but that was not selected for mitigation may have parameters that have changed such that a re-evaluation of the DoS attack by the DoS mitigation manager 139 at a later time may indicate that the DoS attack should then be subject to mitigation. Likewise, a DoS attack currently being mitigated via scrubbers may be re-evaluated by DoS mitigation manager 139, where the DoS mitigation manager 139 may determine that the particular DoS attack no longer warrants mitigation via the use of one or more scrubbers (e.g., in some cases even if the DoS attack is not considered to have ended, e.g., where the system under attack may well have sufficient processing resources to handle the DoS attack on its own without the intervention of the scrubbers). For instance, there may be more urgent, impactful, or otherwise higher-priority DoS attacks that are newly detected and that may be computed to have a higher-priority with respect to the use of one or more of the scrubbers.

In addition, in one example, the DoS mitigation manager 139 may train the machine learning model to generate an output comprising a mitigation priority value using a training data set of labeled vectors. For instance, each labeled vector may include an information set associated with a respective DoS attack alert. In addition, each labeled vector may be associated with a respective label indicating whether a respective DoS attack associated with the respective DoS attack alert was designated for mitigation, e.g., by network personnel or another automated system, etc. For instance, network personnel may receive DoS attack alerts via devices 131-134 and may manually select to mitigate or may designate a DoS attack for omission of mitigation. These selections may then be used as labels for machine learning model training. In another example, each labeled vector may be associated with a respective label indicating a mitigation priority level, value, score, or the like, associated with the respective DoS attack alert, e.g., as selected by network personnel or another automated system. Similarly, in one example, the DoS mitigation manager 139 may train the second machine learning model to generate a second output comprising the selected scrubber type (e.g., a DoS attack scrubber unit type) using a training data set of labeled vectors, e.g., where each label may indicate a selected scrubber type. For instance, the DoS mitigation manager 139 may learn over time which DoS scrubber types are most suitable for mitigation of different misuse types (e.g., different types of DoS attacks) based upon how DoS attacks/attack alerts have been allocated to scrubbers for mitigation. Alternatively, or in addition, DoS mitigation manager 139 may monitor the effectiveness of mitigations of DoS attacks of different misuse types via different DoS scrubbers, e.g., using one or more performance indicators (e.g., KPIs). The effectiveness metrics may then be used as labels for training data for training the second MLM.

It should be noted that as referred to herein, a machine learning model (MLM) (or machine learning-based model), may comprise a machine learning algorithm (MLA) that has been “trained” or configured in accordance with input data (e.g., training data) to perform a particular service, e.g., to generate an output comprising a mitigation priority value, to generate a second output comprising the selected denial of service attack scrubber unit type, and so forth. For instance, an MLM may comprise a deep learning neural network, or deep neural network (DNN), a convolutional neural network (CNN), a recurrent neural network (RNN), a long short-term memory (LSTM) model, a generative adversarial network (GAN), a decision tree algorithm/model, such as gradient boosted decision tree (GBDT) (e.g., XGBoost, XGBR, or the like). In other examples, one or more of the MLMs of the present disclosure may comprise a language model (e.g., a large language model (LLM)), such as a bidirectional encoder representations from transformers (BERT) model (e.g., BERT-Base, BERT-Large, etc.), a generative pre-training (GPT) model (e.g. GPT, GPT-2, GPT-3, or the like), a pathways language model (PaLM) a Language Model for Dialogue Applications (LaMDA) model, or other generative language models. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

As noted above, DoS mitigation manager 139 may be configured to perform various steps, functions, and/or operations for transmitting at least one instruction to at least one denial of service attack scrubber unit to mitigate a denial of service attack in response to a mitigation priority value obtained via a machine learning model indicating that the denial of service attack is to be mitigated, as described herein. For instance, an example method for transmitting at least one instruction to at least one denial of service attack scrubber unit to mitigate a denial of service attack in response to a mitigation priority value obtained via a machine learning model indicating that the denial of service attack is to be mitigated is illustrated in FIG. 3 and described in greater detail below. Similarly, DoS mitigation manager 139 may perform various additional operations as described in connection with FIG. 2, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of DoS attack detection system 138, DoS mitigation manager 139, server(s) 135, or the like may be distributed at different locations, such as in or connected to access networks 110 and 120, in another service network connected to Internet 160 (e.g., a cloud computing provider), in communication service provider network 150, and so forth. Thus, these and other modifications are all contemplated within the scope of the present disclosure.

FIG. 2 illustrates an example process 200 for ingesting new DoS attack alerts and retiring existing/older DoS attack alerts, in accordance with the present disclosure. In one example, the process 200 may be performed by a processing system, such as DoS mitigation manager 139 in FIG. 1 and/or any one or more components thereof, or the like. As illustrated in FIG. 2, in a first stage 210, the processing system may obtain new DoS attack alerts 205 and place the alerts into a wait set. At stage 220, the DoS attack alerts in the wait set as well as alerts in a mitigation set may be pulled in by an alert analyzer, e.g., a module or component of the processing system. At stage 230, the processing may determine if the DoS attack alerts remain active. For instance, this may include communicating with a DoS attack detection/alerting system (such as DoS attack detection system 138 of FIG. 1) to confirm that DoS attack alerts are still active. DoS attack alerts that are no longer active may be placed in a removal set at stage 280. In one example, at stage 280, the processing system may scan any DoS attack alerts in the removal set to determine if such alert(s) is/are assigned to any scrubber. For any such DoS attack alert assigned to mitigation via one or more scrubbers, the processing system may communicate with such scrubber(s) to instruct that the alert should no longer be processed by the scrubber(s). For DoS attack alerts that remain active, the process 200 may proceed to stage 240 where the processing system may apply a prediction engine to the alerts. For instance, the prediction engine may include a machine learning model (MLM) implemented by the processing system as described herein that is configured to generate an output comprising a mitigation priority value for a given DoS attack alert. At stage 250, the processing system may determine whether to mitigate a DoS attack associated with a DoS attack alert, e.g., based on the mitigation priority value. For instance, the processing system may apply a threshold, e.g., such that a mitigation priority value that exceeds the threshold may be designated for mitigation. For a DoS attack alert that does not exceed the threshold, the processing system may place the alert back in the wait set, e.g., in accordance with stage 210. Otherwise, for a DoS attack alert that may exceed (or at least meet the threshold), the processing system may send the alert to scrubbers, where scrubber processes may be applied at stage 260. In one example, stage 260 may include assigning a DoS attack alert (e.g., assigning a DoS attack associated with the alert) to one or more scrubbers based on one or more factors, such as a misuse type, scrubber capacity, etc. In addition, DoS alerts/attacks designated for mitigation and assigned to scrubbers may remain in a mitigation set per stage 270. For instance, as noted above, DoS alerts/attacks remaining in the mitigation set may be pulled in for alert analysis at stage 220, evaluated for whether the respective alerts remain active at stage 230, and so forth. As noted, DoS alerts/attacks may be pulled from the mitigation set and may be placed back into the wait set if it is determined at stage 250 that the DoS alert/attack no longer warrants mitigation at a current time. Eventually, a DoS alert/attack may be placed in the removal set at stage 280 when the alert ends or when the severity of the attack is deemed to be relatively low (e.g., falling below the threshold or where updated KPI metrics may indicate that the DoS attack is no longer a significant threat).

It should be noted that the foregoing description of the example process 200 is just one example of ingesting new DoS attack alerts and retiring existing/older DoS attack alerts in accordance with the present disclosure, and that other, further, and different examples may comprise a process with additional steps, fewer steps, alternative steps, steps performed in a different order and/or in parallel, and so forth. For instance, in another example, all active DoS attack alerts may be maintained in a unified data structure, where each DoS attack alert may indicate whether or not the alert is currently assigned to one or more scrubbers for mitigation (and/or which may indicate the scrubber(s) to which the DoS attack/alert is assigned). In other words, the wait set and mitigation set may be integrated rather than maintained as separate lists/databases. Thus, these and other modifications are all contemplated within the scope of the present disclosure.

FIG. 3 illustrates a flowchart of an example method 300 for transmitting at least one instruction to at least one denial of service attack scrubber unit to mitigate a denial of service attack in response to a mitigation priority value obtained via a machine learning model indicating that the denial of service attack is to be mitigated. In one example, steps, functions, and/or operations of the method 300 may be performed by a device as illustrated in FIG. 1, e.g., DoS mitigation manager 139, or the like. Alternatively, or in addition, the steps, functions and/or operations of the method 300 may be performed by a processing system collectively comprising a plurality of devices as illustrated in FIG. 1 such as DoS mitigation manager 139 in conjunction with DoS attack detection system 138, scrubbers 115, 125, 158, and/or 187, servers 135, network component(s) 155, node(s) 185, elements of access network(s) 110 and/or 120, devices 111-113 and/or 121-123, and so forth. In one example, the steps, functions, or operations of method 300 may be performed by a computing device or system 400, and/or a processing system 402 as described in connection with FIG. 4 below. For instance, the computing device 400 may represent at least a portion of a platform, a server, a system, and so forth, in accordance with the present disclosure. For illustrative purposes, the method 300 is described in greater detail below in connection with an example performed by a processing system. The method 300 begins in step 305 and proceeds to step 310.

At step 310, the processing system obtains a DoS attack alert for a DoS attack. For instance, the DoS attack alert may be obtained from a DoS attack detection system (such as DoS attack detection system 138 of FIG. 1 as discussed above). The DoS attack alert may indicate a misuse type. In addition, the DoS attack alert may include further information about the DoS attack, such as: a time of the attack, a source IP address, a source autonomous system number, a traffic volume, a normalized traffic volume per misuse type, a source country, a normalized traffic volume per source country, and so forth.

At step 320, the processing system applies an input vector comprising information associated with the DoS attack alert to a machine learning model (MLM) implemented by the processing system that is configured to generate an output comprising a mitigation priority value. For instance, in one example, the mitigation priority value may comprise a mitigation priority score. In one example, the mitigation priority value may indicate whether the DoS attack is to be mitigated. For example, the mitigation priority value (e.g., a mitigation priority score) may indicate that the DoS attack is to be mitigated when the mitigation priority score exceeds a threshold. In one example, the threshold may be set based upon at least one load level of at least one DoS attack scrubber unit (e.g., at least one DoS attack scrubber unit that is available to the processing system to be assigned to mitigate the DoS attack associated with the DoS attack alert). In another example, the mitigation priority value may comprise a binary indicator of whether to mitigate the DoS attack at a present time. In one example, the output may further comprise a selected DoS attack scrubber unit type. For instance, the MLM may be configured to generate an output comprising the mitigation priority value and the selected (e.g., recommended) DoS attack scrubber unit type.

In one example, the information associated with the DoS attack alert may comprise at least one of: a source IP address, a source autonomous system number, a traffic volume, a normalized traffic volume per misuse type, a source country, a normalized traffic volume per source country, or the like. In this regard, it should be noted that one or more aspects of the information may include a normalization that is via an algorithm or methodology such as maxabsscaler, or the like. To further illustrate, the normalized traffic volume per misuse type may be associated with a first misuse type, where the first misuse type is one of a plurality of defined misuse types, and where the plurality of misuse types may comprise at least two of: a DNS amplification misuse type, an IP fragmentation misuse type, a TCP synchronization flood misuse type, a NTP amplification misuse type, a UDP attack misuse type, a CLDAP amplification misuse type, a TCP reset flood misuse type, or the like.

In one example, the machine learning model may be trained using a training data set of labeled vectors, where each labeled vector includes an information set associated with a respective DoS attack alert, and where each labeled vector is associated with a respective label indicating whether a respective DoS attack associated with the respective DoS attack alert was designated for mitigation. In another example, the machine learning model may be trained using a training data set of labeled vectors, where each labeled vector includes an information set associated with a respective DoS attack alert, and where each labeled vector is associated with a respective label indicating a mitigation priority level associated with the respective DoS attack alert. In one example, the machine learning model may comprise a gradient boosting model, e.g., XGBoost or the like. In another example, the machine learning model may comprise a language model, e.g., a LLM, such as a GPT model, etc. In still another example, the machine learning model may be of a different type such as discussed above.

At optional step 330, the processing system may select at least one DoS attack scrubber unit from among a plurality of DoS attack scrubber units (e.g., for assignment/allocation to mitigate the DoS attack). In one example, the selecting may be based upon a misuse type associated with the DoS attack. For example, the misuse type may be one of a plurality of defined misuse types. For instance, as noted above the plurality of misuse types may comprise at least two of: a DNS amplification misuse type, an IP fragmentation misuse type, a TCP synchronization flood misuse type, a NTP amplification misuse type, a UDP attack misuse type, a CLDAP amplification misuse type, a TCP reset flood misuse type, or the like. As noted above, in one example, the output of the MLM at step 320 may further comprise a selected DoS attack scrubber unit type. In such an example, the at least one DoS attack scrubber unit may be of the selected DoS attack scrubber unit type.

In one example, optional step 330 may include applying, in response to the mitigation priority value indicating that the DoS attack is to be mitigated, a second input vector comprising second information associated with the DoS attack alert to a second machine learning model (MLM) implemented by the processing system that is configured to generate a second output comprising the selected DoS attack scrubber unit type. For instance, the second input vector and second information may be the same as the (first) input vector and (first) information applied to the (first) machine learning model at step 220, or may be a different set of information (e.g., which may be a subset of the first, or which may include different features and/or partially overlapping features, or the like). It should also be noted that in one example, the at least one DoS attack scrubber unit may comprise a DoS attack scrubber system comprising a plurality of DoS attack scrubber units.

At step 340, the processing system transmits at least one instruction to at least one DoS attack scrubber unit to mitigate the DoS attack in response to the mitigation priority value indicating that the DoS attack is to be mitigated. In one example, step 340 may include placing the DoS attack in a mitigation queue for the at least one DoS attack scrubber unit, wherein a position in the mitigation queue is based on the mitigation priority score. Following step 340, the method 300 ends in step 395.

It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-340 for additional DoS attacks/alerts, and so forth. As noted above, in some cases, mitigation of DoS attacks that are currently in process via one or more scrubbers may be terminated, e.g., even if the DoS attack alert remains active. Accordingly, in one example, the method 300 may be expanded to include re-evaluating the DoS attack alert (e.g., evaluating an updated information set associated with the DoS attack alert) at a later time, such as via stage 220 of FIG. 2, determining that the output of the MLM indicates that the DoS attack is not to be mitigated, and transmitting an instruction to the assigned DoS attack scrubber unit(s) to cease mitigation for the particular DoS attack alert. In such an example, the information about the DoS attack may include a duration of the attack and/or a duration of the alert. For instance, as a duration of an attack persists, the mitigation priority may increase. Similarly, in another example, the method 300 may include evaluating a second DoS attack alert (e.g., an information set associated therewith), such as via stage 220 of FIG. 2, and determining that the output of the MLM indicates that the DoS attack is not to be mitigated, and placing the DoS attack alert into a wait queue for reevaluation at a later time. In addition, in one example, the method 300 may be further include removing inactive/expired DoS attack alerts from the wait queue, and so forth.

In still another example, the processing system may include the at least one scrubber unit. In such case, step 340 may include the processing system performing/implementing the mitigation. For instance, the mitigation may include the scrubber unit(s) advertising for traffic associated with a protected system that was the target of the DoS attack. For instance, the scrubber unit(s) may transmit Border Gateway Protocol (BGP) messages or the like to indicate that the scrubber unit(s) is/are to be routed traffic for the IP address(es) associated with the attack target system(s). The traffic for the IP address(es) may then be scanned and rate-limited to the target system(s), selectively dropped (e.g., legitimate traffic may pass, suspect traffic (e.g., based on the source IP address, flow, country or countries of origin, etc.), may be isolated, e.g., in a honey pot, may be further processed for attack signature creation, for cross-correlation with other threat knowledge (e.g., if a source IP address is known to be associated with other malicious activity), and so forth. The mitigation may also include generating alerts to network personnel, to owners/operators of protected systems, and so on. In one example, the mitigation may include load balancing between alternate servers, instantiating a virtual machine to emulate a protected system, and so forth. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method 300 can be stored, displayed and/or outputted either on the device executing the method 300, or to another device, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

FIG. 4 depicts a high-level block diagram of a computing device or processing system specifically programmed to perform the functions described herein. For example, any one or more components or devices illustrated in FIG. 1, or described in connection with the examples of FIGS. 2 and 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for transmitting at least one instruction to at least one denial of service attack scrubber unit to mitigate a denial of service attack in response to a mitigation priority value obtained via a machine learning model indicating that the denial of service attack is to be mitigated, and various input/output devices 406, e.g., a camera, a video camera, storage devices, including but not limited to, a tape drive, a floppy drive) a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for transmitting at least one instruction to at least one denial of service attack scrubber unit to mitigate a denial of service attack in response to a mitigation priority value obtained via a machine learning model indicating that the denial of service attack is to be mitigated (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for transmitting at least one instruction to at least one denial of service attack scrubber unit to mitigate a denial of service attack in response to a mitigation priority value obtained via a machine learning model indicating that the denial of service attack is to be mitigated (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a denial of service attack alert for a denial of service attack;
applying, by the processing system, an input vector comprising information associated with the denial of service attack alert to a machine learning model implemented by the processing system that is configured to generate an output comprising a mitigation priority value; and
transmitting, by the processing system, at least one instruction to at least one denial of service attack scrubber unit to mitigate the denial of service attack in response to the mitigation priority value indicating that the denial of service attack is to be mitigated.

2. The method of claim 1, further comprising:
selecting the at least one denial of service attack scrubber unit from among a plurality of denial of service attack scrubber units of a denial of service attack scrubber system.

3. The method of claim 2, wherein the selecting is based upon a misuse type associated with the denial of service attack.

4. The method of claim 3, wherein the misuse type is one of a plurality of defined misuse types, wherein the plurality of defined misuse types comprises at least two of:
a domain name system flood misuse type;
a domain name system amplification misuse type;
an internet protocol fragmentation misuse type;
a transmission control protocol synchronization flood misuse type;
a network time protocol amplification misuse type;
a uniform datagram protocol attack misuse type;
a connection-less lightweight directory access protocol amplification misuse type; or
a transmission control protocol reset flood misuse type.

5. The method of claim 2, wherein the output further comprises a selected denial of service attack scrubber unit type, wherein the at least one denial of service attack scrubber unit is of the selected denial of service attack scrubber unit type.

6. The method of claim 2, wherein the selecting of the at least one denial of service attack scrubber unit comprises:
applying, in response to the mitigation priority value indicating that the denial of service attack is to be mitigated, a second input vector comprising second information associated with the denial of service attack alert to a second machine learning model implemented by the processing system that is configured to generate a second output comprising the selected denial of service attack scrubber unit type.

7. The method of claim 1, wherein the information associated with the denial of service attack alert comprises at least one of:
a source internet protocol address;
a source autonomous system number;
a traffic volume;
a normalized traffic volume per misuse type;
a source country; or
a normalized traffic volume per source country.

8. The method of claim 7, wherein the normalized traffic volume per misuse type is associated with a first misuse type, wherein the first misuse type is one of a plurality of defined misuse types, wherein the plurality of misuse type comprises at least two of:
a domain name system flood misuse type;
a domain name system amplification misuse type;
an internet protocol fragmentation misuse type;
a transmission control protocol synchronization flood misuse type;
a network time protocol amplification misuse type;
a uniform datagram protocol attack misuse type;
a connection-less lightweight directory access protocol amplification misuse type; or
a transmission control protocol reset flood misuse type.

9. The method of claim 1, wherein the mitigation priority value comprises a mitigation priority score.

10. The method of claim 9, wherein the mitigation priority score indicates that the denial of service attack is to be mitigated when the mitigation priority score exceeds a threshold.

11. The method of claim 10, wherein the threshold is set based upon at least one load level of the at least one denial of service attack scrubber unit.

12. The method of claim 9, wherein the transmitting of the at least one instruction includes placing the denial of service attack in a mitigation queue for the at least one denial of service attack scrubber unit, wherein a position in the mitigation queue is based on the mitigation priority score.

13. The method of claim 1, wherein the mitigation priority value comprises a binary indicator of whether to mitigate the denial of service attack at a present time.

14. The method of claim 1, wherein the machine learning model is trained using a training data set of labeled vectors, wherein each labeled vector includes an information set associated with a respective denial of service attack alert, wherein each labeled vector is associated with a respective label indicating whether a respective denial of service attack associated with the respective denial of service attack alert was designated for mitigation.

15. The method of claim 1, wherein the machine learning model is trained using a training data set of labeled vectors, wherein each labeled vector includes an information set associated with a respective denial of service attack alert, wherein each labeled vector is associated with a respective label indicating a mitigation priority level associated with the respective denial of service attack alert.

16. The method of claim 1, wherein the machine learning model comprises a gradient boosting model.

17. The method of claim 1, wherein the machine learning model comprises a language model.

18. A non-transitory computer-readable medium storing instructions which, when executed by a processing system including at least one processor, cause the processing system to perform operations, the operations comprising:
obtaining a denial of service attack alert for a denial of service attack;
applying an input vector comprising information associated with the denial of service attack alert to a machine learning model implemented by the processing system that is configured to generate an output comprising a mitigation priority value; and
transmitting at least one instruction to at least one denial of service attack scrubber unit to mitigate the denial of service attack in response to the mitigation priority value indicating that the denial of service attack is to be mitigated.

19. The non-transitory computer-readable medium of claim 18, wherein the operations further comprise:
selecting the at least one denial of service attack scrubber unit from among a plurality of denial of service attack scrubber units of a denial of service attack scrubber system.

20. An apparatus comprising:
a processing system including at least one processor; and
a computer-readable medium storing instructions which, when executed by the processing system, cause the processing system to perform operations, the operations comprising:
obtaining a denial of service attack alert for a denial of service attack;
applying an input vector comprising information associated with the denial of service attack alert to a machine learning model implemented by the processing system that is configured to generate an output comprising a mitigation priority value; and
transmitting at least one instruction to at least one denial of service attack scrubber unit to mitigate the denial of service attack in response to the mitigation priority value indicating that the denial of service attack is to be mitigated.
